(19) United States
(12) Patent Application Publication
(10) Pub. No.: US 2026/0320963 A1
(43) Pub. Date: Oct. 15, 2026

(54) IMAGE PROCESSING METHOD AND APPARATUS, DEVICE, AND STORAGE MEDIUM

(71) Applicant: CHINA UNIONPAY CO., LTD., Shanghai (CN)

(72) Inventors: Zhijun FEI, Shanghai (CN); Xuetao QIU, Shanghai (CN); Xufeng LV, Shanghai (CN); Yanming YANG, Shanghai (CN)

(21) Appl. No.: 19/482,620

(22) PCT Filed: Apr. 22, 2024
(86) PCT No.: PCT/CN2024/089197

§ 371 Date: Nov. 7, 2025

(30) Foreign Application Priority Data
May 9, 2023 (CN) 202310517942.6

(51) Int. Cl. G06V 10/26; G06V 10/25; G06V 10/44; G06V 10/74; G06V 10/82

(52) U.S. Cl. CPC G06V 10/26; G06V 10/25; G06V 10/44; G06V 10/761; G06V 10/82

(57) ABSTRACT

The present disclosure provides an image processing method, apparatus, device, and storage medium, relating to the field of artificial intelligence technology. The method includes: obtaining a to-be-processed image (S201); performing a preliminary segmentation on the to-be-processed image to determine a region of interest containing a card surface element (S202); performing a focus processing on the region of interest to obtain a core region of the card surface element (S203); constructing a pixel retrieval tree based on the core region; and segmenting the region of interest using the pixel retrieval tree to obtain a target region where the card surface element is located (S204). The present disclosure improves the accuracy and effectiveness of locating card surface elements, and eliminates the need for data labeling and model training during the process of locating card surface elements, thereby improving the efficiency of card surface element locating and reducing costs. Furthermore, the method employed in the present disclosure is highly robust and may achieve good results even under complex background conditions.

### CROSS-REFERENCE TO RELATED APPLICATION

This application claims priority to the Chinese patent application filed with the State Intellectual Property Office of China on May 9, 2023, with application No. 202310517942.6 and application title “IMAGING PROCESSING METHOD AND APPARATUS, DEVICE, AND STORAGE MEDIUM”, the entire content of which is incorporated by reference into this application.

### FIELD OF THE DISCLOSURE

The present disclosure generally relates to the field of artificial intelligence technology and, more particularly, relates to an image processing method, apparatus, device, and storage medium.

### BACKGROUND

In practical applications, the size and position of bank card surface elements must meet compliance requirements, but manual judgment of such compliance is difficult. Therefore, a recognition device is needed to locate card surface elements and automatically determine their compliance based on the locating results and business rules.

Related technologies use deep neural networks to perform semantic segmentation on bank card images and determine the locations of card surface elements on the cards. However, the data used to train deep neural networks includes the original images and their corresponding semantically labelled images. Semantic labels are obtained by manually labeling each pixel in the original images. Manual classification and labeling inevitably lead to labeling errors, and inconsistencies may occur when different people label the same image. This results in low accuracy when using deep neural networks to perform semantic segmentation on bank card images, which in turn affects the accuracy of locating card surface elements.

### SUMMARY

The embodiments of the present disclosure provide an image processing method, apparatus, device, and storage medium for improving the accuracy of locating card surface elements.

An embodiment of the present disclosure provides an image processing method, the method including: obtaining a to-be-processed image; performing a preliminary segmentation on the to-be-processed image to determine a region of interest containing a card surface element; performing a focus processing on the region of interest to obtain a core region of the card surface element; and constructing a pixel retrieval tree based on the core region; and segmenting the region of interest using the pixel retrieval tree to obtain a target region where the card surface element is located.

In one aspect, an embodiment of the present disclosure provides an image processing apparatus, including: an acquisition module, configured to obtain a to-be-processed image; an image segmentation module, configured to perform a preliminary segmentation on the to-be-processed image to determine a region of interest containing a card surface element; a focusing module, configured to perform a focus processing on the region of interest to obtain a core region of the card surface element; and a locating module, configured to construct a pixel retrieval tree based on the core region; and segment the region of interest using the pixel retrieval tree to obtain a target region where the card surface element is located.

Optionally, the focusing module is specifically configured to: extract an edge feature within the region of interest; and based on the edge feature, cut the core region of the card surface element out from the region of interest.

Optionally, the locating module is specifically configured to: take pixels in the core region as an initial set of seed pixels; and iteratively update the seed pixel set until the seed pixel set meets an iteration stop condition, and using the seed pixel set obtained when the iteration stops as the target region where the card surface element is located, where each iteration process includes: constructing the pixel retrieval tree using a candidate pixel set adjacent to the seed pixel set; and obtaining at least one matching connected region from the region of interest based on the pixel retrieval tree, and merging the at least one matching connected region into the seed pixel set.

Optionally, the locating module is specifically configured to: search, from the region of interest, a plurality of matching pixels that match the pixel retrieval tree; determine the at least one pixel-connected region based on the obtained plurality of matching pixels; and based on an association relationship between the at least one pixel-connected region and the region of interest, select the at least one matching connected region from the at least one pixel-connected region.

Optionally, the locating module is specifically configured to: for each pixel in the region of interest, convert a pixel value of the pixel into a string; and if a string corresponding to the pixel matches a node in the pixel retrieval tree, determine the pixel to be a matching pixel.

Optionally, the locating module is specifically configured to: for each pixel-connected region, if there is an overlapping region between the pixel-connected region and the region of interest, and a ratio of an area of the overlapping region to an area of the pixel-connected region is greater than a preset threshold, determine the pixel-connected region to be a matching connected region.

Optionally, the seed pixel set meeting the iteration stop condition means that the seed pixel set no longer changes.

Optionally, the focusing module is specifically configured to: based on a fact that a center position of the region of interest does not change, perform a focus processing on a length and width of the region of interest by a preset value respectively to obtain the core region of the card surface element.

Optionally, the locating module is specifically configured to: construct the pixel retrieval tree based on pixels within the core region; expand the region of interest to obtain an expanded result region; and obtain at least one matching connected region from the expanded result region based on the pixel retrieval tree, and merge the at least one matching connected region into the core region to obtain the target region where the card surface element is located.

Optionally, the locating module is specifically configured to: search, from the expanded result region, a plurality of matching pixels that match the pixel retrieval tree; determine at least one pixel-connected region based on the obtained plurality of matching pixels; and for each pixel-connected region, if an area of the pixel-connected region is greater than or equal to a preset threshold, determine the pixel-connected region to be a matching connected region.

Optionally, the locating module is specifically configured to: for each pixel in the expanded result region, convert a pixel value of the pixel into a string; and if a string corresponding to the pixel matches a node in the pixel retrieval tree, determine the pixel to be a matching pixel.

Optionally, the image segmentation module is specifically configured to: use a deep neural network model to perform the preliminary segmentation on the to-be-processed image to determine the region of interest containing the card surface element.

Optionally, the image segmentation module is further configured to: segment the region of interest using the pixel retrieval tree to obtain the target region where the card surface element is located, and then use the to-be-processed image with a labelled target region as a training sample to update the deep neural network model.

On one hand, an embodiment of the present disclosure provides a computer device, including a memory, a processor, and a computer program stored in the memory and executable on the processor, where the processor implements the steps of the above-described image processing method when executing the program.

On one hand, an embodiment of the present disclosure provides a computer-readable storage medium, which stores a computer program that may be executed by a computer device. When the program is run on the computer device, the computer device executes the steps of the above-described image processing method.

On one hand, an embodiment of the present disclosure provides a computer program product, which includes a computer program stored on a computer-readable storage medium, and the computer program includes program instructions. When the program instructions are executed by a computer, the computer performs the steps of the above-described image processing method.

In the embodiments of the present disclosure, a preliminary segmentation is first performed on a to-be-processed image to determine a region of interest containing a card surface element; then, a focus processing is performed on the region of interest to obtain a core region of the card surface element; then, utilizing the similarity of pixel distribution patterns within a same card surface element, a pixel retrieval tree is constructed based on the core region; and the pixel retrieval tree is used to segment the region of interest to obtain a target region where the card surface element is located, thereby improving the accuracy of locating the card surface elements and improving the locating effect of the card surface elements. Secondly, the present disclosure does not require data annotation and model training in the process of locating a card surface element, thereby improving the efficiency of locating the card surface element and reducing costs. In addition, the methods adopted in the present disclosure is highly robust and may still achieve good results under complex background conditions.

### BRIEF DESCRIPTION OF THE DRAWINGS

In order to more clearly illustrate the technical solutions in the embodiments of the present disclosure, the following briefly introduces the drawings required for use in the description of the embodiments. Apparently, the drawings described below are merely some embodiments of the present disclosure. For a person skilled in the art, other drawings may be obtained based on these drawings without making creative efforts.

FIG. 1 is a system architecture diagram provided by an embodiment of the present disclosure;

FIG. 2 is a flowchart of an image processing method provided by an embodiment of the present disclosure;

FIG. 3 is a schematic structural diagram of a deep neural network model provided by an embodiment of the present disclosure;

FIG. 4 is a second flowchart of an image processing method provided by an embodiment of the present disclosure;

FIG. 5 is a third flowchart of an image processing method provided by an embodiment of the present disclosure;

FIG. 6 is a schematic structural diagram of an image processing apparatus provided by an embodiment of the present disclosure; and

FIG. 7 is a schematic structural diagram of a computer device provided by an embodiment of the present disclosure.

### DETAILED DESCRIPTION

In order to make the purpose, technical solutions and beneficial effects of the present disclosure more clearly understood, the present disclosure will be further described in detail below with reference to the accompanying drawings and embodiments. It should be understood that the specific embodiments described herein are merely used to explain the present disclosure and are not intended to limit the present disclosure.

For ease of understanding, the terms involved in the embodiments of the present disclosure are explained below.

ROI: Region of interest.

Faster R-CNN: Faster region-convolutional neural network (CNN), a fast end-to-end object detection deep neural network.

YOLO: You only look once, a commonly used algorithm in target detection algorithms.

U-net: U-shaped network, a U-shaped convolutional neural network.

FCN: Fully convolutional network.

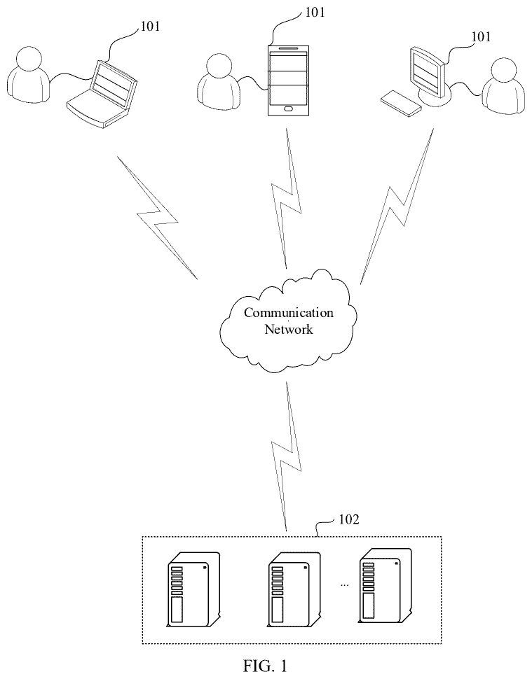

Refer to FIG. 1, which is a system architecture diagram applicable to an embodiment of the present disclosure. The system architecture includes at least a terminal device 101 and a server 102. The number of terminal devices 101 may be one or more, and the number of servers 102 may also be one or more. The present disclosure does not specifically limit the number of terminal devices 101 and servers 102.

An application for locating card surface elements is pre-installed in a terminal device 101, where the application is a client application, a web application, a mini-program application, etc. The terminal device 101 may be a smartphone, a tablet computer, a laptop computer, a desktop computer, a smart home appliance, an intelligent voice interaction device, an intelligent vehicle-mounted device, etc., but the present disclosure is not limited thereto.

A server 102 is a backend server for the application. The server 102 may be a standalone physical server, a server cluster or distributed system composed of multiple physical servers, or a cloud server that provides basic cloud computing services such as cloud services, cloud databases, cloud computing, cloud functions, cloud storage, network services, cloud communications, middleware services, domain name services, security services, content delivery networks (CDNs), and big data and artificial intelligence platforms. The terminal device 101 and the server 102 may be connected directly or indirectly via wired or wireless communication, which is not limited in the present disclosure.

The image processing method in the embodiments of the present disclosure may be executed by the terminal device 101, may be executed by the server 102, or may be executed interactively by the terminal device 101 and the server 102.

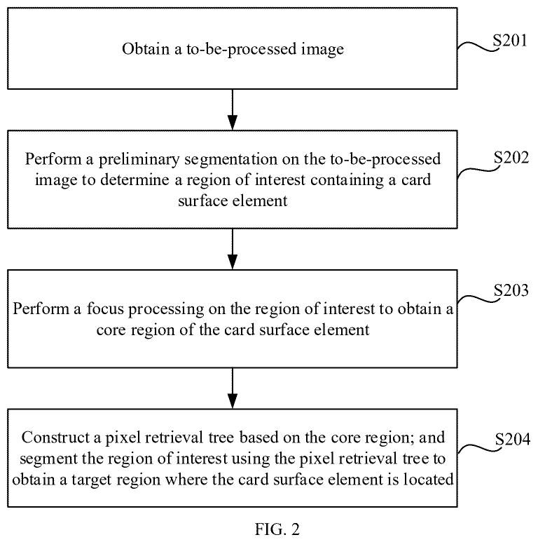

Based on the system architecture diagram shown in FIG. 1, an embodiment of the present disclosure provides a flowchart of an image processing method, as shown in FIG. 2. The flowchart of the method is executed by a computer device, which may be the terminal device 101 and/or the server 102 shown in FIG. 1, and includes the following steps.
Step S201: Obtain a to-be-processed image.

Specifically, the to-be-processed image may be an image of a bank card, a shopping card, a membership card, etc. The to-be-processed image may be obtained by taking a photo or may be a design drawing, which is not specifically limited in the present disclosure.
Step S202: Perform a preliminary segmentation on the to-be-processed image to determine a region of interest containing a card surface element.

In some embodiments, a deep neural network model is used to perform the preliminary segmentation on the to-be-processed image to determine the region of interest containing the card surface element, where the deep neural network model may be a deep network model such as U-Net, FCN, Faster R-CNN, YOLO, etc.

In some embodiments, in addition to using a deep neural network model to obtain a region of interest containing the card surface element, the type of the card surface element may also be obtained.

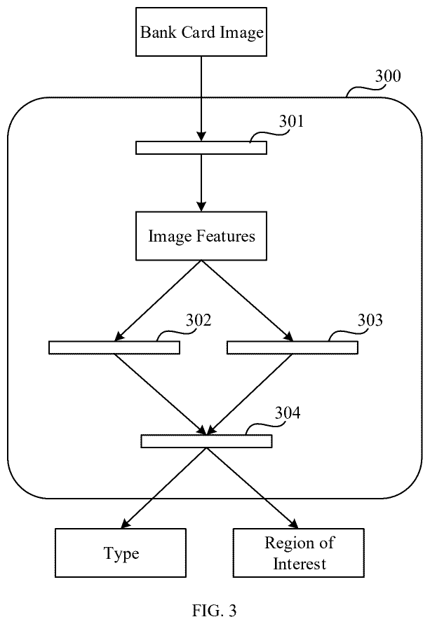

Taking the Faster R-CNN deep neural network model as an example, referring to FIG. 3, a deep neural network model 300 includes a convolutional layer 301, a region proposal network (RPN) 302, a target region pooling layer 303, and a classifier 304. A bank card image is input into the convolutional layer 301, which extracts image features from the bank card image and then shares these features with the RPN 302 and the region pooling layer 303. The RPN 302 generates candidate region image blocks based on the image features to locate a region of interest of the card surface. The region pooling layer 303 extracts a feature map of the region of interest based on the image features. Based on the candidate region image blocks and the feature map of the region of interest, the classifier 304 outputs the card surface element type and the region of interest.
Step S203: Perform a focus processing on the region of interest to obtain a core region of the card surface element.

Specifically, performing the focus processing on the region of interest includes: cropping the region of interest to remove the background region in the region of interest, or removing the background region in the region of interest and the peripheral region of the card surface element, so as to obtain the core region of the card surface element.

In some embodiments, with the center position of the region of interest kept unchanged as a reference, a focus processing is performed on the length and width of the region of interest by a preset value to obtain the core region of the card surface element.

Specifically, when the card surface element contains only a few of color features, such as the chip logo on a bank card, a focus processing is performed on the length and width of the region of interest by a preset value to obtain the core region of the card surface element.

For example, a bank card image is input into a deep neural network model. The model outputs the region of interest of the card surface element as follows: ROI=[(xroimin, yroimin), (xroimax, yroimax)]. With the center position of the region of interest kept unchanged as a reference, a focus processing is performed on the length and width of the region of interest by a preset value a, and the core region of the card surface element is obtained as: ROIF=[(xroimin+a, yroimin+a), (xroimax-a, yroimax-a)]. The core region (ROIF) contains all the pixels of the card surface element.

In some embodiments, an edge feature within the region of interest is extracted; and based on the edge feature, the core region of the card surface element is cut out from the region of interest.

Specifically, when the card surface element contains many color features, such as the bank logo on a bank card, an edge feature E0 within the region of interest is extracted, and then the edges, in the edge feature E0, that are connected to the outside of the region of interest are removed to obtain the core region E1 of the card surface element.
Step S204: Construct a pixel retrieval tree based on the core region; and segment the region of interest using the pixel retrieval tree to obtain a target region where the card surface element is located.

Specifically, the pixel retrieval tree includes multiple nodes, each corresponding to a string. Using the pixel retrieval tree, the region of interest is finely segmented to obtain a precise region where the card surface element is located.

In the embodiments of the present disclosure, a preliminary segmentation is first performed on a to-be-processed image to determine a region of interest containing a card surface element; then, a focus processing is performed on the region of interest to obtain a core region of the card surface element; then, utilizing the similarity of pixel distribution patterns within a same card surface element, a pixel retrieval tree is constructed based on the core region; and the pixel retrieval tree is used to segment the region of interest to obtain the target region where the card surface element is located, thereby improving the accuracy of locating the card surface element and improving the locating effect of the card surface element. Secondly, the present disclosure does not require data annotation and model training in the process of locating a card surface element, thereby improving the efficiency of locating the card surface element and reducing costs. In addition, the methods adopted in the present disclosure is highly robust and may still achieve good results under complex background conditions.

Optionally, in the above step S204, the pixel retrieval tree is constructed based on the pixels in the core region; then the region of interest is expanded to obtain an expanded result region; at least one matching connected region is obtained from the expanded result region based on the pixel retrieval tree, and at least one matching connected region is merged into the core region to obtain the target region where the card surface element is located.

Specifically, a region is expanded by using the region of interest as the center, and the obtained expanded result region is: ROIE=[(xroimin-b, yroimin-b), (xroimax+b, yroimax+b)], so that the card surface element is completely contained in the expanded result region.

Multiple matching pixels that match the pixel retrieval tree are searched from the expanded result region. Then, based on the obtained multiple matching pixels, at least one pixel-connected region is determined. For each pixel-connected region, if the area of the pixel-connected region is greater than or equal to a preset threshold, the pixel-connected region is determined to be a matching connected region.

Specifically, for each pixel in the expanded result region, the pixel value of the pixel is converted into a string; if the string corresponding to the pixel matches a node in the pixel retrieval tree, the pixel is a matching pixel; and if the string corresponding to the pixel does not match any node in the pixel retrieval tree, the pixel is a non-matching pixel.

In practical applications, for each pixel in the expanded result region, the pixel value of the pixel is set to [R, G, B], and the pixel value of the pixel is converted into a string str(R)+str(G)+str(B), where str means converting a number into a string and retaining 3 valid digits. For example: if R=12, then str (R)=“012”, and “+” denotes a string concatenation operation.

Determine whether the string str(R)+str(G)+str(B) matches the pixel retrieval tree (PT), that is, whether the node corresponding to the string str(R)+str(G)+str(B) in the pixel retrieval tree is 1; if so, the pixel matches a node in the pixel retrieval tree, that is, the pixel is a matching pixel and the original pixel value is retained, otherwise the pixel is set to 0.

Based on the obtained multiple matching pixels, at least one pixel-connected region is determined, and the area of each pixel-connected region is calculated. When the area of a pixel-connected region is less than a preset threshold smin, the pixels within the pixel-connected region are set to zero. Finally, a precise pixel set composed of the remaining non-zero pixel-connected regions is merged into the core region to obtain the target region where the card surface element is located. The coordinate range [(xmin, ymin), (xmax, ymax)] of the pixels in the precise pixel set is used as the location of the target region in the bank card image.

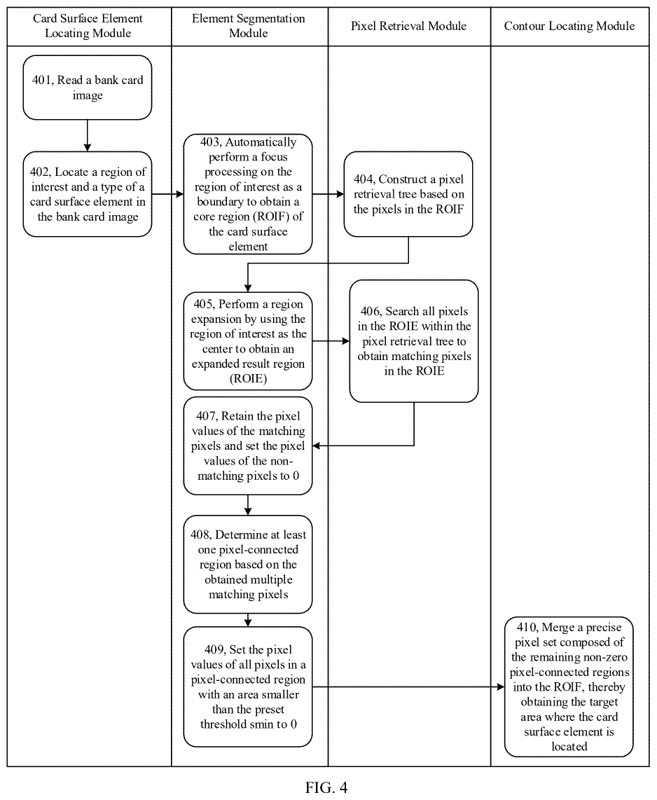

For example, referring to FIG. 4, which is a flowchart of an image processing method provided in an embodiment of the present disclosure, the method is interactively executed by a card surface element locating module, an element segmentation module, a pixel retrieval module, and a contour locating module in a server, and includes the following steps.
Step 401: The card surface element locating module reads a bank card image.
Step 402: The card surface element locating module locates a region of interest and a type of card surface element in the bank card image through Faster R-CNN.
Step 403: The element segmentation module automatically performs a focus processing on the region of interest as a boundary to obtain a core region of the card surface element.

Specifically, when the type of the card surface element is a preset element type with only a few of color features (such as a chip logo), step 403 and subsequent steps are executed; otherwise, the subsequent steps are not executed.
Step 404: The pixel retrieval module constructs a pixel retrieval tree based on the pixels in the core region.
Step 405: The element segmentation module performs a region expansion by using the region of interest as the center to obtain an expanded result region.
Step 406: The pixel retrieval module searches all pixels in the expanded result region within the pixel retrieval tree to obtain matching pixels in the expanded result region.
Step 407: The element segmentation module retains the pixel values of the matching pixels and sets the pixel values of the non-matching pixels to 0.
Step 408: The element segmentation module determines at least one pixel-connected region based on the obtained multiple matching pixels.
Step 409: The element segmentation module sets the pixel values of all pixels in a pixel-connected region with an area smaller than the preset threshold smin to 0.
Step 410: The contour locating module merges a precise pixel set composed of the remaining non-zero pixel-connected regions into the core region, thereby obtaining the target area where the card surface element is located.

In the embodiments of the present disclosure, a preliminary segmentation is first performed on a to-be-processed image to determine a region of interest containing a card surface element; then a focus processing is performed on the region of interest to obtain a core region of the card surface element; then, by utilizing the similarity of the pixel distribution patterns within the same card surface element, a pixel retrieval tree is constructed based on the core region, and pixel-connected regions that match the pixel retrieval tree in the expanded result region of the region of interest is searched, and finally, pixel-connected regions with an area greater than a preset threshold are merged into the core region of the card surface element to obtain the target region where the card surface element is located, thereby improving the accuracy and locating effect of the card surface element locating. Secondly, the present disclosure does not require data annotation and model training in the process of locating a card surface element, thereby improving the efficiency of locating the card surface element and reducing costs. In addition, the methods adopted in the present disclosure is highly robust and may still achieve good results under complex background conditions.

Optionally, in step S204, the pixels in the core region are used as an initial seed pixel set; the seed pixel set is iteratively updated until the seed pixel set meets the iteration stop condition, and the seed pixel set obtained when the iteration stops is determined to be the target region where the card surface element is located, where each iteration process includes: constructing a pixel retrieval tree using a candidate pixel set adjacent to the seed pixel set; then, obtaining at least one matching connected region from the region of interest based on the pixel retrieval tree, and merging the at least one matching connected region into the seed pixel set.

Specifically, first obtain a candidate pixel set (CS) adjacent to the seed pixel set, select the color elements in the candidate pixel set to construct a pixel tree, or combine the candidate pixel set and the atomic pixel set to construct a pixel tree. Then, based on the pixel retrieval tree, obtain at least one matching connected region from the region of interest. Apparently, it is also possible to obtain at least one matching connected region from the to-be-processed image based on the pixel retrieval tree, which is not specifically limited in the present disclosure. The seed pixel set meets the iteration stop condition when the seed pixel set no longer changes.

In some embodiments, multiple matching pixels that match the pixel retrieval tree are retrieved from the region of interest; then, based on the obtained multiple matching pixels, at least one pixel-connected region is determined; and then, based on an association relationship between the at least one pixel-connected region and the region of interest, at least one matching connected region is selected from the at least one pixel-connected region.

Specifically, for each pixel in the region of interest, the pixel value is converted into a string; if the string corresponding to the pixel matches a node in the pixel retrieval tree, the pixel is a matching pixel. If the string corresponding to the pixel does not match any node in the pixel retrieval tree, the pixel is a non-matching pixel.

In practical applications, for each pixel in the expanded result region, the pixel value of the pixel is set to [R, G, B], and the pixel value of the pixel is converted into a string str(R)+str(G)+str(B), where str means converting a number into a string and retaining 3 valid digits. For example: if R=12, then str (R)=“012”, and “+” denotes a string concatenation operation.

Determine whether the string str(R)+str(G)+str(B) matches the pixel retrieval tree, that is, whether the node corresponding to the string str(R)+str(G)+str(B) in the pixel retrieval tree is 1; if so, the pixel matches a node in the pixel retrieval tree, that is, the pixel is a matching pixel and the original pixel value is retained, otherwise the pixel is set to 0.

Based on the obtained multiple matching pixels, at least one pixel-connected region may be determined. For each pixel-connected region, if there is an overlapping region between the pixel-connected region and the region of interest, and the ratio of the area of the overlapping region to the area of the pixel-connected region is greater than a preset threshold, the pixel-connected region is determined to be a matching connected region. The matching connected region is then merged into a seed pixel set, which now contains more pixels. The next iteration is then performed based on the updated seed pixel set. The iteration stops when the seed pixel set no longer changes, and the seed pixel set obtained at the end of the iteration is determined to be the target region for the card surface element.

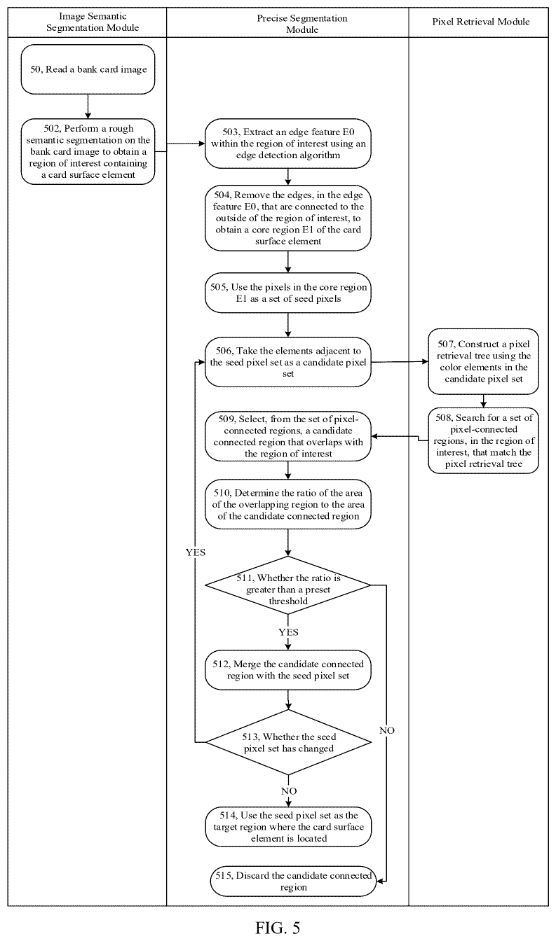

For example, referring to FIG. 5, which is a flowchart of an image processing method provided in an embodiment of the present disclosure, the method is interactively executed by an image semantic segmentation module, a precise segmentation module, and a pixel retrieval module in a server, and includes the following steps.
Step 501: The image semantic segmentation module reads a bank card image.
Step 502: The image semantic segmentation module performs a rough semantic segmentation on the bank card image using a U-Net network to obtain a region of interest containing a card surface element.
Step 503: The precise segmentation module extracts an edge feature E0 within the region of interest using an edge detection algorithm.
Step 504: The precise segmentation module removes the edges, in the edge feature E0, that are connected to the outside of the region of interest, to obtain a core region E1 of the card surface element.
Step 505: The precise segmentation module uses the pixels in the core region E1 as a set of seed pixels.
Step 506: The precise segmentation module takes the elements adjacent to the seed pixel set as a candidate pixel set.
Step 507: The pixel retrieval module constructs a pixel retrieval tree using the color elements in the candidate pixel set.
Step 508: The pixel retrieval module searches for a set of pixel-connected regions, in the region of interest, that match the pixel retrieval tree.
Step 509: The precise segmentation module selects, from the set of pixel-connected regions, a candidate connected region that overlaps with the region of interest.
Step 510: The precise segmentation module determines the ratio of the area of the overlapping region to the area of the candidate connected region.
Step 511: The precise segmentation module determines whether the ratio is greater than a preset threshold. If so, step 512 is executed; otherwise, step 515 is executed.
Step 512: The precise segmentation module merges the candidate connected region with the seed pixel set.
Step 513: The precise segmentation module determines whether the seed pixel set has changed. If so, step 506 is executed; otherwise, step 514 is executed.
Step 514: The precise segmentation module uses the seed pixel set as the target region where the card surface element is located.
Step 515: The precise segmentation module discards the candidate connected region.

In the embodiments of the present disclosure, a preliminary segmentation is first performed on a to-be-processed image to determine a region of interest containing a card surface element; then, a focus processing is performed on the region of interest to obtain the core region of the card surface element; then, utilizing the similarity of the pixel distribution patterns within a same card surface element, the core region is used as the initial seed pixel set, a pixel retrieval tree is iteratively constructed based on the adjacent pixels of the seed pixel set, and a matching connected region that matches the pixel retrieval tree in the region of interest is searched to update the seed pixel set, and the iteration is stopped until the seed pixel set no longer changes. The seed pixel set obtained when the iteration is stopped is determined to be the target region where the card surface element is located, thereby improving the accuracy and locating effect of the card surface element locating. Secondly, the present disclosure does not require data annotation and model training in the process of locating a card surface element, thereby improving the efficiency of locating the card surface element and reducing costs. In addition, the methods adopted in the present disclosure is highly robust and may still achieve good results under complex background conditions.

In any of the above embodiments, a to-be-processed image with a labelled target region is used as a training sample to update the deep neural network model to optimize the deep neural network model in the preliminary segmentation stage, thereby improving the accuracy of the preliminary segmentation of card surface elements.

Based on the similar technical concept, an embodiment of the present disclosure provides a structural diagram of an image processing apparatus, as shown in FIG. 6. The image processing apparatus 600 includes: an acquisition module 601 configured to acquire a to-be-processed image; an image segmentation module 602 configured to perform a preliminary segmentation on the to-be-processed image to determine a region of interest containing a card surface element; a focusing module 603 configured to perform a focus processing on the region of interest to obtain a core region of the card surface element; and a locating module 604 configured to construct a pixel retrieval tree based on the core region; and segment the region of interest using the pixel retrieval tree to obtain a target region where the card surface element is located.

Optionally, the focusing module 603 is specifically configured to: extract an edge feature within the region of interest; and based on the edge feature, cut the core region of the card surface element out from the region of interest.

Optionally, the locating module 604 is specifically configured to: take pixels in the core region as an initial set of seed pixels; and iteratively update the seed pixel set until the seed pixel set meets an iteration stop condition, and use the seed pixel set obtained when the iteration stops as the target region where the card surface element is located, where each iteration process includes: constructing the pixel retrieval tree using a candidate pixel set adjacent to the seed pixel set; and obtaining at least one matching connected region from the region of interest based on the pixel retrieval tree, and merging the at least one matching connected region into the seed pixel set.

Optionally, the locating module 604 is specifically configured to: search a plurality of matching pixels, with the region of interest, that match the pixel retrieval tree; determine at least one pixel-connected region based on the obtained plurality of matching pixels; and based on the association relationship between the at least one pixel-connected region and the region of interest, select at least one matching connected region from the at least one pixel-connected region.

Optionally, the locating module 604 is specifically configured to: for each pixel in the region of interest, convert the pixel value of the pixel into a string; and if the string corresponding to the pixel matches a node in the pixel retrieval tree, determine the pixel to be a matching pixel.

Optionally, the locating module 604 is specifically configured to: for each pixel-connected region, if there is an overlapping region between the pixel-connected region and the region of interest, and the ratio of the area of the overlapping region to the area of the pixel-connected region is greater than a preset threshold, determine the pixel-connected region to be a matching connected region.

Optionally, the seed pixel set meeting the iteration stop condition means that the seed pixel set no longer changes.

Optionally, the focusing module 603 is specifically configured to: based on the fact that the center position of the region of interest does not change, perform a focus processing on the length and width of the region of interest by a preset value respectively to obtain the core region of the card surface element.

Optionally, the locating module 604 is specifically configured to: construct a pixel retrieval tree based on the pixels within the core region; expand the region of interest to obtain an expanded result region; and obtain at least one matching connected region from the expanded result region based on the pixel retrieval tree, and marge the at least one matching connected region into the core region to obtain the target region where the card surface element is located.

Optionally, the locating module 604 is specifically configured to: search, from the expanded result region, a plurality of matching pixels that match the pixel retrieval tree; determine at least one pixel-connected region based on the obtained multiple matching pixels; and for each pixel-connected region, if the area of the pixel-connected region is greater than or equal to a preset threshold, determine the pixel-connected region to be a matching connected region.

Optionally, the locating module 604 is specifically configured to: for each pixel in the expanded result region, convert the pixel value of the pixel into a string; if the string corresponding to the pixel matches a node in the pixel retrieval tree, determine the pixel to be a matching pixel.

Optionally, the image segmentation module 602 is specifically configured to: use a deep neural network model to perform the preliminary segmentation on the to-be-processed image to determine the region of interest containing the card surface element.

Optionally, the image segmentation module 602 is further configured to: segment the region of interest using the pixel retrieval tree to obtain the target region where the card surface element is located, and then use the to-be-processed image with the labelled target region as a training sample to update the deep neural network model.

In the embodiments of the present disclosure, a preliminary segmentation is first performed on a to-be-processed image to determine a region of interest containing a card surface element; then, a focus processing is performed on the region of interest to obtain the core region of the card surface element; then, utilizing the similarity of pixel distribution patterns within a same card surface element, a pixel retrieval tree is constructed based on the core region; and the pixel retrieval tree is used to segment the region of interest to obtain the target region where the card surface element is located, thereby improving the accuracy of locating the card surface elements and improving the locating effect of the card surface elements. Secondly, the present disclosure does not require data annotation and model training in the process of locating a card surface element, thereby improving the efficiency of locating the card surface element and reducing costs. In addition, the methods adopted in the present disclosure is highly robust and may still achieve good results under complex background conditions.

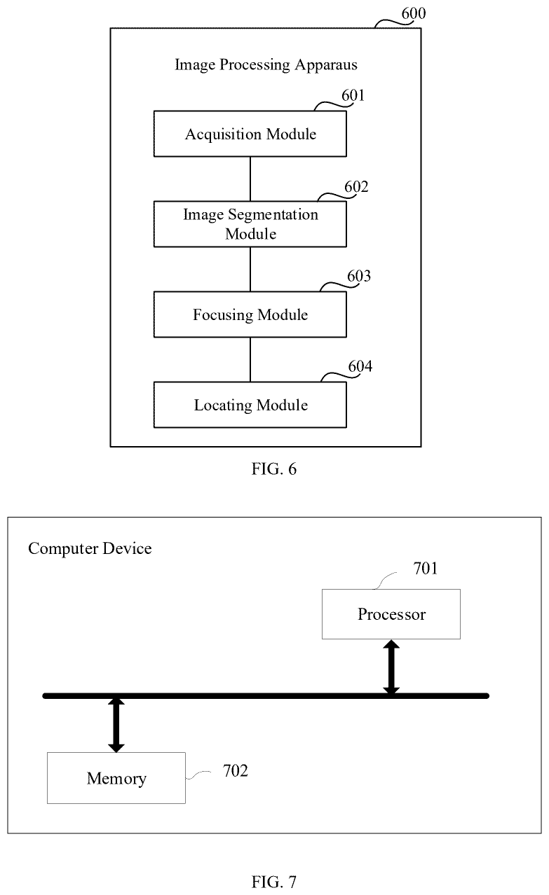

Based on the similar technical concept, an embodiment of the present disclosure provides a computer device, which may be the terminal device and/or server shown in FIG. 1. As shown in FIG. 7, the computer device includes at least one processor 701 and a memory 702 connected to the at least one processor. The embodiment of the present disclosure does not limit the specific connection medium between the processor 701 and the memory 702. FIG. 7 takes the connection between the processor 701 and the memory 702 via a bus as an example. Buses may be categorized into address buses, data buses, control buses, etc.

In an embodiment of the present disclosure, the memory 702 stores instructions that may be executed by at least one processor 701. The at least one processor 701 may perform the steps of the above-described image processing methods by executing the instructions stored in the memory 702.

The processor 701 is the control center of the computer device. It may connect the various components of the computer device using various interfaces and lines. It may achieve card surface element locating by running or executing instructions stored in the memory 702 and calling data stored in the memory 702. Optionally, the processor 701 may include one or more processing units. The processor 701 may integrate an application processor and a modem processor. The application processor mainly processes the operating system, user interface, and application programs, while the modem processor mainly handles wireless communications. It is understood that the modem processor may not be integrated into the processor 701. In some embodiments, the processor 701 and the memory 702 may be implemented on the same chip. In some embodiments, they may also be implemented on separate chips.

The processor 701 may be a general-purpose processor, such as a central processing unit (CPU), a digital signal processor, an application-specific integrated circuit (ASIC), a field-programmable gate array or other programmable logic device, a discrete gate or transistor logic device, or a discrete hardware component, and may implement or execute the various methods, steps, and logic block diagrams disclosed in the embodiments of the present disclosure. A general-purpose processor may be a microprocessor or any conventional processor. The steps of the methods disclosed in the embodiments of the present disclosure may be directly implemented as being executed by a hardware processor, or may be executed by a combination of hardware and software modules in the processor.

The memory 702, as a non-volatile computer-readable storage medium, may be used to store non-volatile software programs, non-volatile computer executable programs, and modules. The memory 702 may include at least one type of storage medium, such as flash memory, a hard disk, a multimedia card, a card-type memory, random access memory (RAM), static random access memory (SRAM), programmable read-only memory (PROM), read-only memory (ROM), electrically erasable programmable read-only memory (EEPROM), magnetic storage, a magnetic disk, an optical disk, and the like. The memory 702 may be any other medium that is used to carry or store desired program code in the form of instructions or data structures and may be accessed by a computer device, but is not limited thereto. In the embodiments of the present disclosure, the memory 702 may also be a circuit or any other apparatus capable of performing a storage function, used to store program instructions and/or data.

Based on the similar inventive concept, an embodiment of the present disclosure provides a computer-readable storage medium, which stores a computer program that may be executed by a computer device. When the program runs on the computer device, the computer device executes the steps of the above-described image processing methods.

Based on the similar inventive concept, an embodiment of the present disclosure provides a computer program product, which includes a computer program stored on a computer-readable storage medium, and the computer program includes program instructions. When the program instructions are executed by a computer device, the computer device performs the steps of the above-described image processing methods.

Those skilled in the art will appreciate that embodiments of the present disclosure may be provided as methods or computer program products. Thus, the present disclosure may take the form of an entirely hardware embodiment, an entirely software embodiment, or an embodiment combining software and hardware aspects. Furthermore, the present disclosure may take the form of a computer program product implemented on one or more computer-usable storage media (including but not limited to magnetic disk storage, CD-ROM, optical storage, etc.) containing computer-usable program code.

The present disclosure is described with reference to flowcharts and/or block diagrams of methods, devices (systems), and computer program products according to embodiments of the present disclosure. It should be understood that each process and/or block in the flowcharts and/or block diagrams, as well as combinations of processes and/or blocks in the flowcharts and/or block diagrams, may be implemented by computer program instructions. These computer program instructions may be provided to a processor of a general-purpose computer, a special-purpose computer, an embedded processor, or other programmable data processing device to produce a machine, such that execution of the instructions by the processor of the computer apparatus or other programmable data processing apparatus produces means for implementing the functions specified in one or more processes in the flowcharts and/or one or more blocks in the block diagrams.

These computer program instructions may also be stored in a computer-readable memory that may direct a computer apparatus or other programmable data processing device to operate in a specific manner, so that the instructions stored in the computer-readable memory produce a product including an instruction device that implements the functions specified in one or more processes in the flowchart and/or one or more blocks in the block diagram.

These computer program instructions may also be loaded onto a computer device or other programmable data processing device, so that a series of operating steps are executed on the computer device or other programmable device to produce a process implemented by the computer device, so that the instructions executed on the computer device or other programmable device provide steps for implementing the functions specified in one or more processes in the flowchart and/or one or more blocks in the block diagram.

Although the preferred embodiments of the present disclosure have been described, those skilled in the art may make additional changes and modifications to these embodiments once they have learned the basic creative concept. Therefore, the appended claims are intended to be interpreted as including the preferred embodiments and all changes and modifications that fall within the scope of the present disclosure.

Apparently, those skilled in the art may make various changes and modifications to the present disclosure without departing from the spirit and scope of the present disclosure. Thus, if such changes and modifications fall within the scope of the claims and their equivalents, the present disclosure is intended to include such changes and modifications.

1. An image processing method, comprising:
obtaining a to-be-processed image;
performing a preliminary segmentation on the to-be-processed image to determine a region of interest containing a card surface element;
performing a focus processing on the region of interest to obtain a core region of the card surface element; and
constructing a pixel retrieval tree based on the core region; and segmenting the region of interest using the pixel retrieval tree to obtain a target region where the card surface element is located.

2. The method according to claim 1, wherein performing the focus processing on the region of interest to obtain the core region of the card surface element comprises:
extracting an edge feature within the region of interest; and
cutting the core region of the card surface element out from the region of interest based on the edge feature.

3. The method according to claim 1, wherein constructing the pixel retrieval tree based on the core region; and segmenting the region of interest using the pixel retrieval tree to obtain the target region where the card surface element is located comprises:
taking pixels in the core region as an initial set of seed pixels; and
iteratively updating a seed pixel set until the seed pixel set meets an iteration stop condition, and using a seed pixel set obtained when the iteration stops as the target region where the card surface element is located, wherein each iteration process includes:
constructing the pixel retrieval tree using a candidate pixel set adjacent to the seed pixel set, and
obtaining at least one matching connected region from the region of interest based on the pixel retrieval tree, and merging the at least one matching connected region into the seed pixel set.

4. The method according to claim 3, wherein obtaining the at least one matching connected region from the region of interest based on the pixel retrieval tree comprises:
searching, from the region of interest, a plurality of matching pixels that match the pixel retrieval tree;
determining at least one pixel-connected region based on the obtained plurality of matching pixels; and
selecting the at least one matching connected region from the at least one pixel-connected region based on an association relationship between the at least one pixel-connected region and the region of interest.

5. The method according to claim 4, wherein searching, from the region of interest, the plurality of matching pixels that match the pixel retrieval tree comprises:
for each pixel in the region of interest, converting a pixel value of the pixel into a string; and
if a string corresponding to the pixel matches a node in the pixel retrieval tree, determining the pixel to be a matching pixel.

6. The method according to claim 4, wherein selecting the at least one matching connected region from the at least one pixel-connected region based on the association relationship between the at least one pixel-connected region and the region of interest comprises:
for each pixel-connected region, if there is an overlapping region between the pixel-connected region and the region of interest, and a ratio of an area of the overlapping region to an area of the pixel-connected region is greater than a preset threshold, determining the pixel-connected region to be a matching connected region.

7. The method according to claim 3, wherein the seed pixel set meeting the iteration stop condition means that the seed pixel set no longer changes.

8. The method according to claim 1, wherein performing the focus processing on the region of interest to obtain the core region of the card surface element comprises:
based on a fact that a center position of the region of interest does not change, performing the focus processing on a length and width of the region of interest by a preset value respectively to obtain the core region of the card surface element.

9. The method according to claim 1, wherein constructing the pixel retrieval tree based on the core region; and segmenting the region of interest using the pixel retrieval tree to obtain the target region where the card surface element is located comprises:
constructing the pixel retrieval tree based on pixels within the core region;
expanding the region of interest to obtain an expanded result region; and
obtaining at least one matching connected region from the expanded result region based on the pixel retrieval tree, and merging the at least one matching connected region into the core region to obtain the target region where the card surface element is located.

10. The method according to claim 9, wherein obtaining the at least one matching connected region from the expanded result region based on the pixel retrieval tree comprises:
searching, from the expanded result region, a plurality of matching pixels that match the pixel retrieval tree;
determining at least one pixel-connected region based on the obtained plurality of matching pixels; and
for each pixel-connected region, if an area of the pixel-connected region is greater than or equal to a preset threshold, determining the pixel-connected region to be a matching connected region.

11. The method according to claim 10, wherein searching, from the expanded result region, the plurality of matching pixels that match the pixel retrieval tree comprises:
for each pixel in the expanded result region, converting a pixel value of the pixel into a string; and
if a string corresponding to the pixel matches a node in the pixel retrieval tree, determining the pixel to be a matching pixel.

12. The method according to claim 1, wherein performing the preliminary segmentation on the to-be-processed image to determine the region of interest containing the card surface element comprises:
using a deep neural network model to perform the preliminary segmentation on the to-be-processed image to determine the region of interest containing the card surface element.

13. The method according to claim 12, wherein, after segmenting the region of interest using the pixel retrieval tree to obtain the target region where the card surface element is located, the method further comprises:
updating the deep neural network model by using the to-be-processed image with a labelled target region as a training sample.

14. (canceled)

15. A computer device comprising a memory, a processor, and a computer program stored in the memory and executable on the processor, wherein when executing the program, the processor is configured to perform:
obtaining a to-be-processed image;
performing a preliminary segmentation on the to-be-processed image to determine a region of interest containing a card surface element;
performing a focus processing on the region of interest to obtain a core region of the card surface element; and
constructing a pixel retrieval tree based on the core region; and segmenting the region of interest using the pixel retrieval tree to obtain a target region where the card surface element is located.

16. A computer-readable storage medium, wherein the computer-readable storage medium stores a computer program executable by a computer device, and when the computer program is run on the computer device, the computer device is configured to perform:
obtaining a to-be-processed image;
performing a preliminary segmentation on the to-be-processed image to determine a region of interest containing a card surface element;
performing a focus processing on the region of interest to obtain a core region of the card surface element; and
constructing a pixel retrieval tree based on the core region; and segmenting the region of interest using the pixel retrieval tree to obtain a target region where the card surface element is located.

17. A computer program product, wherein the computer program product includes a computer program stored on a computer-readable storage medium, the computer program including program instructions, which, when executed by a computer, cause the computer to execute the steps of the method according to claim 1.

18. The computer device according to claim 15, wherein the processor is further configured to perform:
extracting an edge feature within the region of interest; and
cutting the core region of the card surface element out from the region of interest based on the edge feature.

19. The computer device according to claim 15, wherein the processor is further configured to perform:
taking pixels in the core region as an initial set of seed pixels; and
iteratively updating a seed pixel set until the seed pixel set meets an iteration stop condition, and using a seed pixel set obtained when the iteration stops as the target region where the card surface element is located, wherein each iteration process includes:
constructing the pixel retrieval tree using a candidate pixel set adjacent to the seed pixel set, and
obtaining at least one matching connected region from the region of interest based on the pixel retrieval tree, and merging the at least one matching connected region into the seed pixel set.

20. The computer device according to claim 19, wherein the processor is further configured to perform:
searching, from the region of interest, a plurality of matching pixels that match the pixel retrieval tree;
determining at least one pixel-connected region based on the obtained plurality of matching pixels; and
selecting the at least one matching connected region from the at least one pixel-connected region based on an association relationship between the at least one pixel-connected region and the region of interest.

21. The computer device according to claim 20, wherein the processor is further configured to perform:
for each pixel in the region of interest, converting a pixel value of the pixel into a string; and
if a string corresponding to the pixel matches a node in the pixel retrieval tree, determining the pixel to be a matching pixel.
